(19) United States
(12) Patent Application Publication
(10) Pub. No.: US 2025/0342027 A1
(43) Pub. Date: Nov. 6, 2025

(54) DISPLAY SYSTEM AND FIRMWARE UPDATING METHOD

(71) Applicant: REALTEK SEMICONDUCTOR CORP., HSINCHU (TW)

(72) Inventors: CHUN-CHIEH CHAN, HSINCHU (TW); WEI-LUN HUANG, HSINCHU (TW); YEN-CHUN WANG, HSINCHU (TW); Chun-Hua Wang, HSINCHU (TW)

(21) Appl. No.: 18/952,173

(22) Filed: Nov. 19, 2024

(30) Foreign Application Priority Data
May 2, 2024 (TW) 113116301

(51) Int. Cl. G06F 8/65

(52) U.S. Cl. CPC G06F 8/65

(57) ABSTRACT

A display system and a firmware updating method are provided. The display system includes displays connected in series to form a daisy-chain topology. Each of the displays includes firmware, and one of the displays is configured to be a publishing display. The publishing display is configured to execute a publishing program to provide a target version number of the firmware of the publishing display to each of the displays excluding the publishing display through the daisy-chain topology. Each of the displays excluding the publishing display is configured to execute a local program to determine whether or not the firmware needs to be updated based on a current version number of the firmware of the display and the target version number, and, in response to determining that the firmware needs to be updated, the firmware is updated based on a target file content provided by the publishing display.

### CROSS-REFERENCE TO RELATED PATENT APPLICATION

This application claims the benefit of priority to Taiwan Patent Application No. 113116301, filed on May 2, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a display system and a firmware updating method, and more particularly to a display system including multiple displays connected in series to form a daisy-chain topology, and a firmware updating method.

### BACKGROUND OF THE DISCLOSURE

An existing display system may include multiple displays connected in series to form a daisy-chain topology, and an existing firmware updating method requires a user to update the firmware of the displays one-by-one. In such case, more time and labor costs are incurred.

In another existing firmware updating method, a computer is used as a host, in which specialized tools are used at a topmost layer of the daisy-chain topology to update the firmware of the displays. In this case, even though time and labor costs are saved, the convenience is still insufficient.

### SUMMARY OF THE DISCLOSURE

In response to the above-referenced technical inadequacies, the present disclosure provides a display system including multiple displays connected in series to form a daisy-chain topology, and a firmware updating method, such that a computer utilizing specialized tools at a topmost layer of the daisy-chain topology to update the firmware of the displays is not needed.

In order to solve the above-mentioned problems, one of the technical aspects adopted by the present disclosure is to provide a display system. The display system includes a plurality of displays connected in series to form a daisy-chain topology. Each of the plurality of displays includes firmware, and one of the plurality of displays is configured to be a publishing display. The publishing display is configured to execute a publishing program to provide a target version number of the firmware of the publishing display to each of the plurality of displays excluding the publishing display through the daisy-chain topology. Each of the plurality of displays excluding the publishing display is configured to execute a local program to determine whether or not the firmware needs to be updated based on a current version number of the firmware of the display and the target version number, and, in response to determining that the firmware needs to be updated, the firmware is updated based on a target file content provided by the publishing display.

In order to solve the above-mentioned problems, another one of the technical aspects adopted by the present disclosure is to provide a firmware updating method. The firmware updating method is adopted for a display system including a plurality of displays connected in series to form a daisy-chain topology. Each of the plurality of displays includes a firmware. The firmware updating method includes: configuring one of the displays as a publishing display; configuring the publishing display to execute a publishing program to provide a target version number of the firmware of the publishing display to each of the displays excluding the publishing display through the daisy-chain topology; and configuring each of the displays excluding the publishing display to execute a local program to determine whether or not the firmware needs to be updated based on a current version number of the firmware of the display and the target version number, and, in response to determining that the firmware needs to be updated, the firmware is updated based on a target file content provided by the publishing display.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 a functional block diagram of a display system according to one embodiment of the present disclosure;

FIG. 2 is a flowchart of processes of a firmware updating method according to a first embodiment of the present disclosure;

FIG. 3A is a flowchart of processes of a publishing program executed by a target display after the target display is configured as a publishing display and a source location is configured to be at an external storage device according to one embodiment of the present disclosure;

FIG. 3B is a flowchart of processes of a local program executed by each of a plurality of displays excluding the publishing display according to one embodiment of the present disclosure;

FIG. 4A is a schematic diagram of the publishing display executing a downward publishing program according to one embodiment of the present disclosure;

FIG. 4B is a schematic diagram of the publishing display executing a upward publishing program according to one embodiment of the present disclosure; and

FIG. 5 is a schematic diagram of the display system scanning a latest version of firmware in the plurality of displays according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

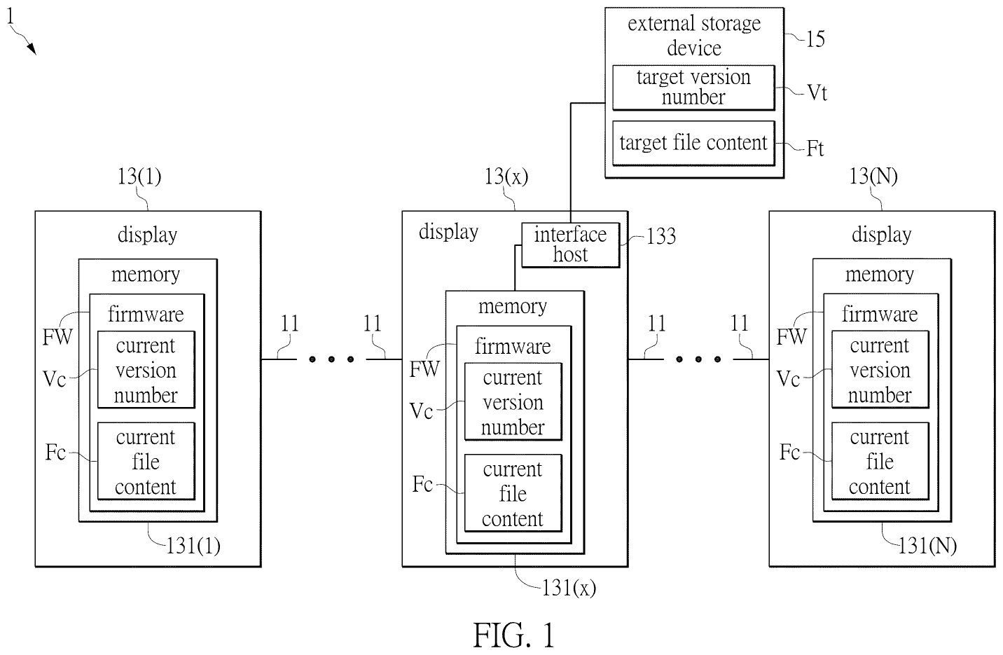

Referring to FIG. 1, FIG. 1 is a functional block diagram of a display system according to one embodiment of the present disclosure. As shown in FIG. 1, a display system 1 may include a plurality of displays 13(1) to 13(N) connected in series to form a daisy-chain topology. That is to say, N is an integer greater than 1, but the present disclosure does not limit a specific value of N.

Specifically, the displays 13(1) to 13(N) can be connected in series through at least one bus 11 to form a daisy-chain topology. For example, the bus 11 can be a DisplayPort™ auxiliary channel, a display data channel of high definition multimedia interface (HDMI), or a transmission channel of universal serial bus (USB). However, the present disclosure is not limited thereto. In addition, the displays 13(1) to 13(N) can be computer screens of a same model number, but the present disclosure is not limited thereto.

In this embodiment, each of the displays has firmware FW, and one of the displays is configured as a publishing display. For example, x is an integer ranging from 1 to N, and a display 13(x) may be configured as the publishing display. However, the present disclosure is not limited to the above-mentioned examples. In addition, the publishing display is configured to execute a publishing program to provide a target version number Vt of the firmware FW to each of the displays excluding the publishing display through the daisy-chain topology. That is to say, the publishing display can provide the target version number Vt of the firmware FW to every other display through the at least one bus 11. How the publishing display obtains the target version number Vt of the firmware FW will be explained through specific embodiments in the following descriptions and will not be iterated herein.

In addition, each of the displays excluding the publishing display is configured to execute a local program to determine whether or not the firmware FW needs to be updated based on a current version number Vc and the target version number Vt of the firmware FW of the display, and, in response to determining that the firmware FW needs to be updated, update the firmware FW according to a target file content Ft provided by the publishing display. That is to say, the publishing display can also provide the target file content Ft of the firmware FW to every other display through the at least one bus 11. Similarly, how the publishing display obtains the target file content Ft of the firmware FW will be explained through specific embodiments in the following descriptions and will not be iterated herein.

Furthermore, each of the displays has a memory to store the current version number Vc and a current file content Fc of the firmware FW, and the target version number Vt refers to a version number to which the firmware FW of each of the displays needs to be updated. Therefore, each of the displays can determine whether or not the firmware FW needs to be updated by comparing the current version number Vc stored in the memory of the display and the target version number Vt and determining whether or not the current version number Vc stored in the memory of the display is the same as the target version number Vt. That is to say, when i is an integer ranging from 1 to N and the current version number Vc stored in an memory 131(i) is the same as the target version number Vt, the display 13(i) can determine that the firmware FW does not need to be updated.

Accordingly, if the current version number Vc stored in the memory 131(i) is different from the target version number Vt, the display 13(i) can determine that the firmware FW needs to be updated. Then, the display 13(i) can write the target file content Ft into the memory 131(i) to replace the current file content Fc stored in the memory 131(i), so as to update the firmware FW. In addition, the target file content Ft corresponds to the target version number Vt. Therefore, after writing the target file content Ft into the memory 131(i), the display 13(i) further replaces the current version number Vc stored in the memory 131(x) with the target version number Vt.

According to the above-mentioned descriptions, when the current version number Vc is smaller than the target version number Vt, the display 13(i) can upgrade the firmware FW. In addition, when the current version number Vc is greater than the target version number Vt, the display 13(i) can downgrade the firmware FW. Therefore, the display system 1 and the firmware updating method of this embodiment can not only realize the effect of firmware upgrade, but can also realize the effect of firmware downgrade.

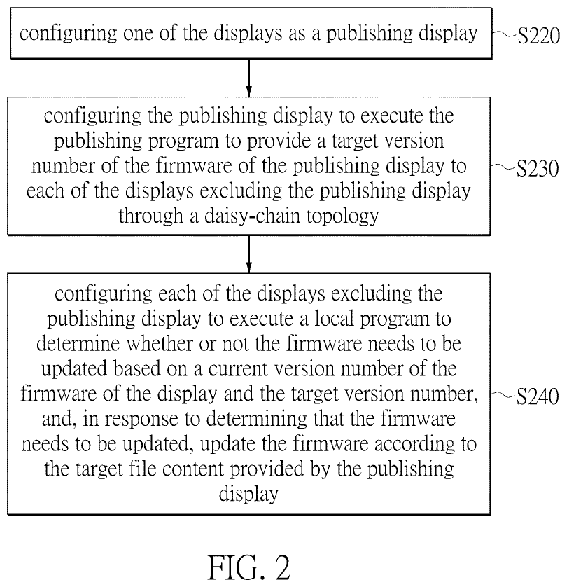

Referring to FIG. 2, FIG. 2 is a flowchart of processes of the firmware updating method according to a first embodiment of the present disclosure. According to the above-mentioned descriptions, the firmware updating method of this embodiment can be applied to the display system 1 of FIG. 1, and as shown in FIG. 2, the firmware updating method of this embodiment includes the following steps.

Step S220 includes: configuring one of the displays as a publishing display.

Step S230 includes: configuring the publishing display to execute the publishing program for providing a target version number of the firmware of the publishing display to each of the displays excluding the publishing display through a daisy-chain topology.

Step S240 includes: configuring each of the displays excluding the publishing display to execute a local program for determining whether or not the firmware needs to be updated based on a current version number of the firmware of the display and the target version number, and, in response to determining that the firmware needs to be updated, update the firmware according to the target file content provided by the publishing display. Since the details of the above-mentioned steps are the same as the above-mentioned descriptions, they will not be reiterated herein.

Further, the display 13(x) is selected as the target display to configure the target version number Vt of the firmware FW and the source location of the target file content Ft. The source location includes the target display. Since the source location is configured to be at the target display, the publishing display defines the current version number Vc and the current file content Fc of the firmware FW of the display 13(x) as the target version number Vt and the target file content Ft. However, the present disclosure is not limited to the above-mentioned examples.

On the other hand, the display system 1 may further include an external storage device 15. The external storage device 15 is configured to store the target version number Vt and the target file content Ft of the firmware FW, and is connected to the display 13(x). That is to say, the source location further includes the external storage device 15. Therefore, if the source location is configured to be at the external storage device 15, the publishing display provides the target version number Vt and the target file content Ft stored in the external storage device 15. How the display 13(x) configured as the publishing display obtains the target version number Vt and the target file content Ft stored in the external storage device 15 will be described in detail below.

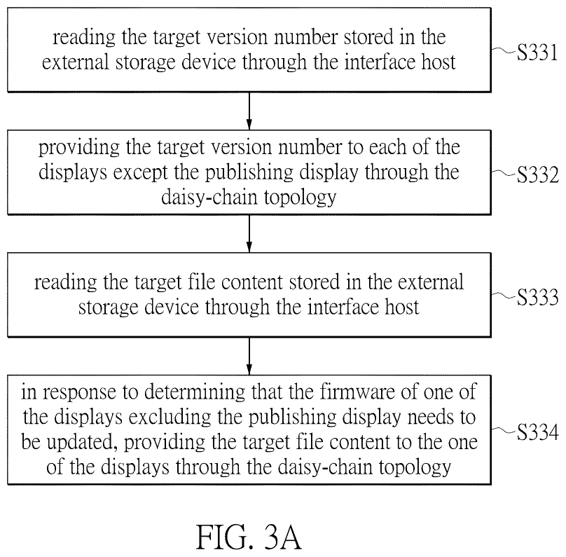

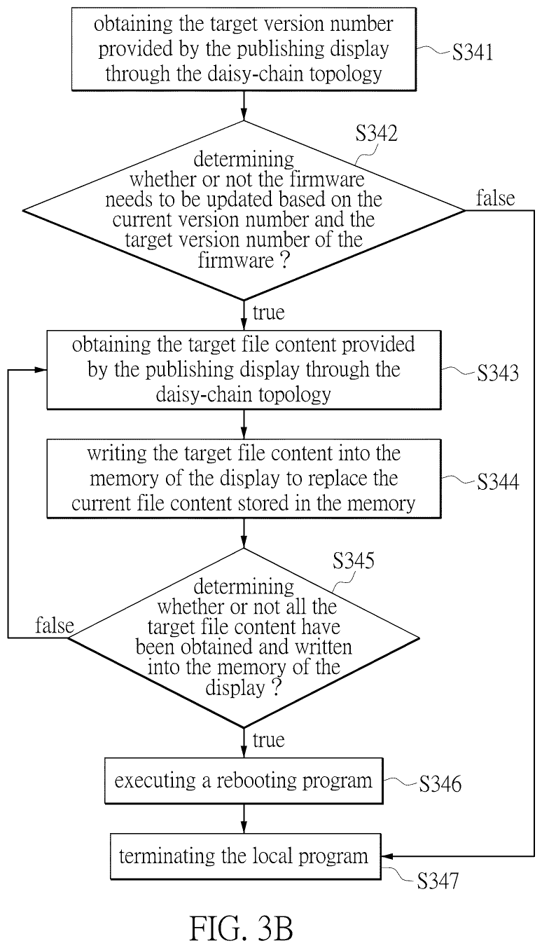

As shown in FIG. 1, the display 13(x) can further include an interface host 133 as a medium for reading the target version number Vt and the target file content Ft stored in the external storage device 15. For example, the external storage device 15 can be a USB mass storage device (MSD), and the interface host 133 can be a USB host. However, the present disclosure is not limited to the above-mentioned examples. Referring to FIG. 3A, FIG. 3A is a flowchart of processes of the publishing program executed by the target display after the target display is configured as a publishing display and the source location is configured to be at an external storage device according to one embodiment of the present disclosure.

As shown in FIG. 3, the publishing program executed after the target display is configured as the publishing display and the source location is configured to be at the external storage device may include the following steps.

Step S331 includes: reading the target version number stored in the external storage device through the interface host.

Step S332 includes: providing the target version number to each of the displays except the publishing display through the daisy-chain topology. That is to say, as shown in FIG. 1, the publishing display can provide the target version number Vt of the firmware FW to each of the displays excluding the publishing display through the at least one bus 11.

Step S333 includes: reading the target file content stored in the external storage device through the interface host. Specifically, if the source location is at an external storage device, the display 13(x) configured as the publishing display will first update the firmware of the display 13(x). Then, the display 13(x) further writes the target file content Ft into the memory 131(x) to replace the current file content Fc stored in the memory 131(x), and replace the current version number Vc stored the memory 131(x) with the target version number Vt. Since the relevant details are similar to the above-mentioned descriptions, they will not be reiterated herein.

Step S334 includes: in response to determining that the firmware of one of the displays excluding the publishing display needs to be updated, providing the target file content to the one of the displays through the daisy- chain topology. That is to say, as shown in FIG. 1, the publishing display can also provide the target file content Ft of the firmware FW through at least one bus 11 to the display that needs to update the firmware FW. Since the relevant details are similar to the above-mentioned descriptions, they will not be reiterated herein. Referring to FIG. 3B, FIG. 3B is a flowchart of processes of the local program executed by each of the displays excluding the publishing display according to one embodiment of the present disclosure.

As shown in FIG. 3B, the local program executed by each of the displays excluding the publishing display can include the following steps.

Step S341 includes: obtaining the target version number provided by the publishing display through the daisy-chain topology. That is to say, as shown in FIG. 1, each of the displays excluding the publishing display can obtain the target version number Vt of the firmware FW through the at least one bus 11.

Step S342 includes: determining whether or not the firmware needs to be updated based on the current version number and the target version number of the firmware; if true, the local program proceeds to step S343; if false, the local program directly proceeds to step S347 to terminate the local program.

Step S343 includes: obtaining the target file content provided by the publishing display through the daisy-chain topology. That is to say, as shown in FIG. 1, each of the displays excluding the publishing display can further obtain the target file content Ft of the firmware FW through the at least one bus 11.

Step S344 includes: writing the target file content into the memory of the display to replace the current file content stored in the memory. Since the relevant details are similar to the above-mentioned descriptions, they will not be reiterated herein.

It should be noted that, since that the target file content Ft may be very large, each of the displays excluding the publishing display can simultaneously obtain the target file content Ft provided by the publishing display and write the target file content Ft into the memory of the display to update the firmware. In this case, the local program executed by each of the displays excluding the publishing display can also include the following steps.

Step S345 includes: determining whether or not all the target file content have been obtained and written into the memory of the display; if false, the local program returns to step S343; if true, the local program proceeds to step S346.

Step S346 includes: executing a rebooting program.

It should be understood that, after the firmware of any of the displays is updated, the display must be rebooted (i.e., the display executing a rebooting program) such that the updated firmware can be used, and after executing the rebooting program, the display can terminate the local program (i.e., proceed to step S347). It should be noted that, the flowcharts of FIG. 3A and FIG. 3B are only some of the possible embodiments, and are not intended to limit the present disclosure thereto.

Furthermore, the displays 13(1) to 13(N) are arranged in an order from an uppermost layer of the daisy-chain topology to a lowermost layer of the daisy-chain topology, and the publishing program executed by the publishing display may include one or a combination of a downward publishing program and an upward publishing program.

The downward publishing program includes sending the target version number Vt and the target file content Ft through a writing request WR to a subsequent one of the displays arranged below the publishing display. That is to say, the publishing display sends the writing request WR including the target version number Vt and the target file content Ft to the next display arranged after the publishing display when executing the downward publishing program, and each of the displays arranged below the publishing display further continues to downwardly send the writing request WR including the target version number Vt and the target file content Ft until reaching a last one of the displays.

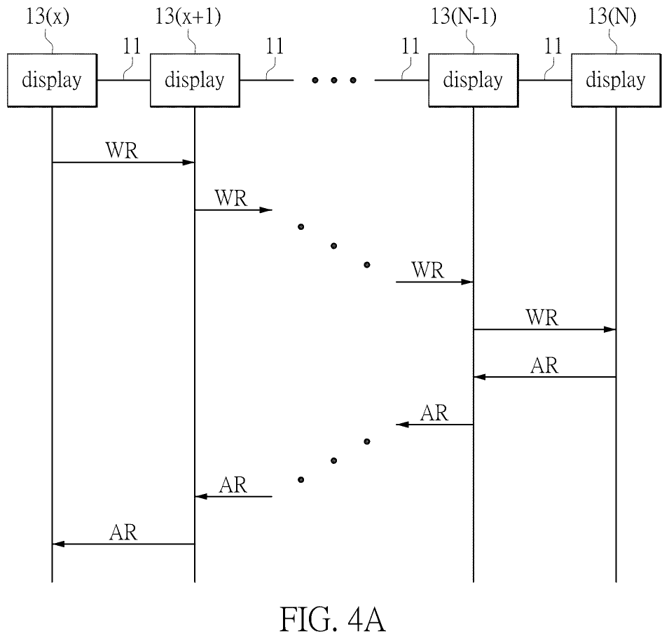

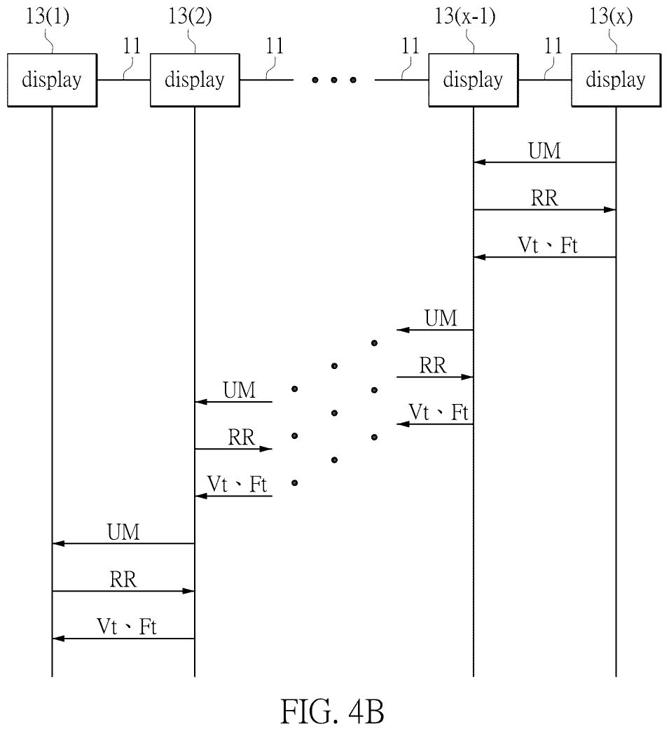

Referring to FIG. 4A, FIG. 4A is a schematic diagram of the publishing display executing the downward publishing program according to one embodiment of the present disclosure. For example, in this embodiment, x is an integer much smaller than N and the display 13(x) is configured as the publishing display. Therefore, as shown in FIG. 4A, the display 13(x) may send the writing request WR including the target version number Vt and the target file content Ft to a display 13(x+1 ), and each of the displays arranged below the display 13(x) further continues to downwardly send the writing request WR including the target version number Vt and the target file content Ft until reaching the display 13(N) (i.e., the last one of the displays).

Specifically, each of the displays arranged below the publishing display executes the local program when receiving the writing request WR, and also sends the writing request WR to a subsequent one of the displays. In addition, the display 13(N) further upwardly sends a confirmation reply AR after executing the local program, and after the publishing display receives the confirmation reply AR sent back from the display 13(N), the publishing display terminates the downward publishing program.

The upward publishing program includes sending an updating notification UM to a previous one of the displays arranged above the publishing display. That is to say, when executing the upward publishing program, the publishing display sends the updating notification UM to a previous display above the publishing display. After the publishing display receives a reading request RR sent by the previous one of the displays, the publishing display sends the target version number Vt and the target file content Ft to the previous one of the displays.

Referring to FIG. 4B, FIG. 4B is a schematic diagram of the publishing display executing the upward publishing program according to one embodiment of the present disclosure. For example, in this embodiment, x is an integer much greater than 1, and the display 13(x) is configured as a publishing display. Therefore, as shown in FIG. 4B, the display 13(x) may send the updating notification UM to the display 13(x−1), and after receiving the reading request RR sent by the display 13(x−1), the display 13(x) can send the target version number Vt and the target file content Ft to the display 13(x−1).

Specifically, each of the displays arranged above the publishing display will return a reading request RR when receiving the updating notification UM to request a subsequent display arranged below the display to provide the target version number Vt and target file content Ft, and after receiving the target version number Vt and the target file content Ft, execute the local program. In addition, after each of the displays arranged above the publishing display finishes executing the local program, the display sends the updating notification UM to a preceding one of the displays arranged above the display, and after receiving the reading request RR sent by the preceding one of the displays, sends the target version number Vt and the target file content Ft to the preceding one of the displays.

In other embodiments, the display system 1 may further include a hub coupled to the publishing display through the bus 11, and the hub may also be coupled to additional displays other than the displays 13(1) to 13(N) through the bus 11. Accordingly, when one of the displays 13(1) to 13(N) sends the updating notification UM to the hub, the hub can return the reading request RR and receive the target version number Vt and the target file content Ft. At this time, the hub can execute the downward publishing program to send the target version number Vt and the target file content Ft through the writing request WR to the aforementioned additional displays.

On the other hand, when at least one of the displays 13(1) to 13(N) is arranged above the hub, the hub can also execute the upward publishing program so as to send the target version number Vt and the target file content Ft to the display arranged above the hub. Since the relevant details are similar to the above-mentioned descriptions, they will not be reiterated herein.

Furthermore, in the present embodiment, the display 13(1) can be configured as the publishing display. Therefore, after the display 13(x) configures the source location of the target version number Vt and the target file content Ft, the display 13(x) can first confirm whether or not the display 13(x) is the display 13(1). If false (i.e., x is an integer greater than 1), the display 13(x) can send an event notification to the display 13(1) to indicate the source location of the target version number Vt and the target file content Ft. Then, if the source location is at the display 13(x) or the external storage device 15, the display 13(1) may send the writing request WR to obtain the target version number Vt and the target file content Ft from the display 13(x). Since the relevant details are similar to the above-mentioned descriptions, they will not be reiterated herein.

It should be noted that, in addition to the display 13(x) and the external storage device 15, the source location of the target version number Vt and the target file content Ft can also be configured to be at one of the displays 13(1) to 13(N) having a latest version of the firmware FW. Therefore, in this case, the display system 1 can assign a unique identifier to each of the displays and scan the displays 13(1) to 13(N) for the latest version of the firmware FW.

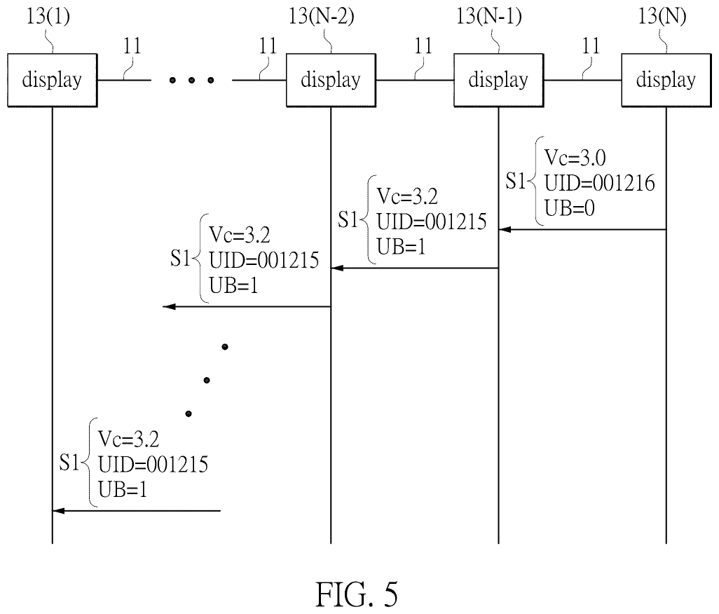

Referring to FIG. 5, FIG. 5 is a schematic diagram of the display system scanning a latest version of firmware in the plurality of displays according to one embodiment of the present disclosure. As shown in FIG. 5, the display 13(1) that is configured as a publishing display can send a request (not shown in FIG. 5) to the display 13(N) to query the unique identifier UID of the display 13(N) and the current version number Vc of the firmware FW of the display 13(N). For example, in this embodiment, the unique identifier UID of the display 13(N) is “001216,” and the current version number Vc of the firmware FW of the display 13(N) is “3.0.” Therefore, as shown in FIG. 5, the display 13(N) can send a signal S1 recording the current version number Vc of the firmware FW and the unique identifier UID of the display 13(N) to the display 13(N−1). In addition, when each of the displays arranged above the display 13(N) receives the signal S1, each of the displays determines whether or not the content of the signal S1 needs to be modified based on the current version number Vc of the firmware FW of each of the displays and the current version number Vc recorded in the signal S1; then, each of the displays sends the signal S1 to a previous one of the displays.

Specifically, each of the displays arranged above the display 13(N) can determine whether or not the content of the signal S1 needs to be modified by comparing the current version number Vc of the firmware FW of each of the displays arranged above the display 13(N) and the current version number Vc recorded in the signal S1 and determining whether or not the current version number Vc of the firmware FW of each of the displays arranged above the display 13(N) is newer than the current version number Vc recorded in the signal S1. That is to say, when i is an integer ranging from 1 to N−1 and the current version number Vc of the firmware FW of the display 13(i) is newer than the current version number Vc recorded in the signal S1, the display 13(i) can determine that the content of the signal S1 needs to be modified and then modify the current version number Vc and the unique identifier UID recorded in the signal S1 to be the current version number Vc and the unique identifier UID of the firmware FW of the display 13(i).

Accordingly, if the current version number Vc of the firmware FW of the display 13(i) is older than the current version number Vc recorded in the signal S1, or if the current version number Vc of the firmware FW of the display 13(i) is same as the current version number Vc recorded in the signal S1, the display 13(i) can determine that the content of the signal S1 does not need to be modified. As shown in FIG. 5, for the display 13(N−1), the unique identifier UID of the display 13(N−1) is “001215,” and the current version number Vc of the firmware FW is “3.2.” In addition, for the display 13(N−2), the unique identifier UID is “001214,” and the current version number Vc of the firmware FW is “3.0.” Therefore, as shown in FIG. 5, after receiving the signal S1, the display 13(N−1) can determine that the content of the signal S1 needs to be modified and modify the current version number Vc and the unique identifier UID recorded in the signal S1 to be the current version number Vc of the firmware FW of the display 13(N−1) and the unique identifier UID of the display 13(N−1). Then, the display 13(N−1) sends the signal S1 to the display 13(N−2).

On the other hand, after the display 13(N−2) receives the signal S1, since the current version number Vc of the firmware FW of the display 13(N−2) is older than the current version number Vc recorded in the signal S1, the display 13(N−2) can determine that the content of the signal S1 does not need to be modified (i.e., original information that is recorded in the signal S1 is maintained), and the display 13(N−2) then sends the signal S1 to a previous one of the displays. Finally, when the display 13(1) receives the signal S1, the display 13(1) compares the current version number Vc of the firmware FW of the display 13(1) and the current version number Vc recorded in the signal S1 to determine whether or not the current version number Vc of the firmware FW of the display 13(1) is newer than the current version number Vc recorded in the signal S1. If the current version number Vc of the firmware FW of the display 13(1) is newer than the current version number Ve recorded in the signal S1, the display 13(1) can define the current version number Vc of the firmware FW of the display 13(1) and the current file content Fc as the target version number Vt and the target file content Ft, and execute the downward publishing program.

Accordingly, if the current version number Vc of the firmware FW of the display 13(1) is older than the current version number Vc recorded in the signal S1, the display 13(1) can send a reading request RR (not shown in FIG. 5) to the corresponding display according to the unique identifier UID recorded in the signal S1 to request the corresponding display to provide the current version number Vc of the firmware FW and the current file content Fc to the display 13(1). In this case, the display 13(1) can define the current version number Vc and the current file content Fc provided by the corresponding display as the target version number Vt and the target file content Ft. Furthermore, the display 13(1) then updates the firmware of the display 13(1) and executes the downward publishing program. Since the relevant details are similar to the above-mentioned descriptions, they will not be reiterated herein.

In this embodiment, the content of the signal S1 can further include a feature bit UB used to indicate whether or not the firmware FW of the displays 13(1) to 13(N) need to be updated, and a default value of the feature bit UB has a first bit value (e.g., 0). Specifically, when the current version number Vc of the firmware FW of the display 13(i) is different from the current version number Vc recorded in the received signal S1, the feature bit UB will be set to a second bit value (e.g., 1).

In addition, if the current version number Vc of the firmware FW of the display 13(1) is the same as the current version number Vc recorded in the signal S1, the display 13(1) can check the feature bit UB to determine whether or not the firmware FW of the displays 13(1) to 13(N) need to be updated. Specifically, if the feature bit UB has the preset first bit value, the display 13(1) can determine that the firmware FW of the displays 13(1) to 13(N) do not need to be updated. In addition, if the feature bit UB has the second bit value, the display 13(1) can determine that the firmware FW of the displays 13(1) to 13(N) need to be updated.

In other embodiments, if the display 13(1) is further coupled to a computer as a host through the bus 11, the display system 1 may interrupt the communication between the display 13(1) and the host before scanning the firmware FW of the displays 13(1) to 13(N) to prevent the host from sending requests that can cause conflicts of tasks.

### BENEFICIAL EFFECTS OF THE EMBODIMENTS

In conclusion, one of the beneficial effects of the present disclosure is that, in the display system and the firmware updating method provided by the present disclosure, by virtue of “one of the plurality of displays being configured as a publishing display,” “the publishing display being configured to execute a publishing program to provide a target version number of the firmware of the publishing display to each of the plurality of displays excluding the publishing display through the daisy-chain topology,” and “each of the plurality of displays excluding the publishing display being configured to execute a local program to determine whether or not the firmware needs to be updated based on a current version number of the firmware of the display and the target version number, and, in response to determining that the firmware needs to be updated, the firmware being updated based on a target file content provided by the publishing display,” a computer utilizing specialized tools at a topmost layer of the daisy-chain topology to update the firmware of the displays is not needed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A display system, comprising:
a plurality of displays connected in series to form a daisy-chain topology, wherein each of the plurality of displays includes firmware, and one of the plurality of displays is configured to be a publishing display;
wherein the publishing display is configured to execute a publishing program to provide a target version number of the firmware of the publishing display to each of the plurality of displays excluding the publishing display through the daisy-chain topology;
wherein each of the plurality of displays excluding the publishing display is configured to execute a local program to determine whether or not the firmware needs to be updated based on a current version number of the firmware of the display and the target version number, and, in response to determining that the firmware needs to be updated, the firmware is updated based on a target file content provided by the publishing display.

2. The display system according to claim 1, wherein each of the displays further includes a memory to store the current version number and a current file content of the firmware, and one of the displays is selected as a target display to configure a source location of the target version number and the target file content of the firmware.

3. The display system according to claim 2, wherein the source location includes the target display, and in response to the source location being configured to be at the target display, the publishing display defines the current version number and the current file content of the firmware of the target display as the target version number and the target file content.

4. The display system according to claim 3, further comprising:
an external storage device configured to store the target version number and the target file content of the firmware, wherein the external storage device is connected to the target display, and the source location further includes the external storage device.

5. The display system according to claim 4, wherein, in response to the target display being configured as the publishing display and the source location being configured to be at the external storage device, the publishing program executed by the publishing display includes processes of:
reading the target version number stored in the external storage device through an interface host;
providing the target version number through the daisy-chain topology to each of the displays excluding the publishing display;
reading the target file content stored in the external storage device through the interface host; and
in response to determining that the firmware of one of the displays excluding the publishing display needs to be updated, providing the target file content to the one of the displays through the daisy-chain topology.

6. The display system according to claim 5, wherein the local program executed by each of the displays excluding the publishing display includes processes of:
determining whether or not the firmware needs to be updated based on the current version number and the target version number of the firmware of the display;
in response to determining that the firmware needs to be updated, obtaining the target file content provided by the publishing display through the daisy-chain topology;
writing the target file content into the memory of the display to replace the current file content stored in the memory;
determining whether or not the target file content is completely obtained and written into the memory of the display; and
in response to determining that the target file content is completely obtained and written into the memory of the display, executing a rebooting procedure.

7. The display system according to claim 3, wherein the displays are arranged in an order from an uppermost layer of the daisy-chain topology to a lowermost layer of the daisy-chain topology, and the publishing program executed by the publishing display includes one or a combination of a downward publishing program and an upward publishing program.

8. The display system according to claim 7, wherein the downward publishing program includes sending the target version number and the target file content through a writing request to a subsequent one of the displays arranged below the publishing display, and each of the displays arranged below the publishing display further continues to downwardly send the writing request including the target version number and the target file content until a last one of the displays.

9. The display system according to claim 8, wherein, after the last one of the displays executes the local program, the last one of the displays upwardly sends a confirmation reply, and after the publishing display receives the confirmation reply from the last one of the displays, the publishing display terminates the downward publishing program.

10. The display system according to claim 9, wherein the upward publishing program includes sending an updating notification to a previous one of the displays arranged above the publishing display, and sending, after receiving a reading request sent by the previous one of the displays, the target version number and the target file content to the previous one of the displays.

11. The display system according to claim 10, wherein each of the displays arranged above the publishing display further sends the updating notification to a preceding one of the displays arranged above the publishing display after completing the execution of the local program, and, after receiving a reading request sent by the preceding one of the displays, sends the target version number and the target file content to the preceding one of the displays.

12. The display system according to claim 7, wherein, in response to a first one of the displays being configured as the publishing display, the source location further includes one of the displays having a latest version of the firmware, and, in response to the source location being configured to be at one of the displays having the latest version of the firmware, the display system assigns a unique identifier to each of the displays.

13. The display system according to claim 12, wherein the publishing display is further configured to send a request to a last one of the displays to query the unique identifier and the current version number of the firmware of the last one of the displays, and the last one of the displays sends a signal recording the current version number and the unique identifier to an adjacent one of the displays arranged above the last one of the displays.

14. The display system according to claim 13, wherein, when each of the displays arranged above the last one of the displays receives the signal, based on the current version number of the firmware of each of the displays arranged above the last one of the displays and the current version number recorded in the signal, each of the displays arranged above the last one of the displays determines whether or not a content of the signal needs to be modified and then sends the signal to a previous one of the displays.

15. The display system according to claim 14, wherein, when the publishing display receives the signal, the publishing display is further configured to determine whether or not the current version number of the firmware of the publishing display is newer than the current version number recorded in the signal by comparing the current version number of the firmware of the publishing display and the current version number recorded in the signal, and, in response to the current version number of the firmware of the publishing display being newer than the current version number recorded in the signal, the publishing display defines the current version number and the current file content of the firmware of the publishing display as the target version number and the target file content.

16. The display system according to claim 15, wherein, in response to the current version number of the firmware of the publishing display being older than the current version number recorded in the signal, based on the unique identifier recorded in the signal, the publishing display sends a reading request to a corresponding one of the displays to request the corresponding display to provide the current version number and the current file content of the firmware of the corresponding display to the publishing display.

17. A firmware updating method adopted for a display system including a plurality of displays connected in series to form a daisy-chain topology, each of the plurality of displays including a firmware, wherein the firmware updating method includes:
configuring one of the displays as a publishing display;
configuring the publishing display to execute a publishing program to provide a target version number of the firmware of the publishing display to each of the displays excluding the publishing display through the daisy- chain topology; and
configuring each of the displays excluding the publishing display to execute a local program to determine whether or not the firmware needs to be updated based on a current version number of the firmware of the display and the target version number, and, in response to determining that the firmware needs to be updated, the firmware is updated based on a target file content provided by the publishing display.

18. The firmware updating method according to claim 17, wherein each of the displays further includes a memory to store the current version number and a current file content of the firmware, and one of the displays is selected as a target display to configure a source location of the target version number and the target file content of the firmware.

19. The firmware updating method according to claim 18, wherein an external storage device configured to store the target version number and the target file content of the firmware, and wherein the external storage device is connected to the target display.

20. The firmware updating method according to claim 19, wherein, in response to the target display being configured as the publishing display and the source location being configured to be at the external storage device, the publishing program executed by the publishing display includes processes of:
reading the target version number stored in the external storage device through an interface host;
providing the target version number through the daisy-chain topology to each of the displays excluding the publishing display;
reading the target file content stored in the external storage device through the interface host; and
in response to determining that the firmware of one of the displays excluding the publishing display needs to be updated, providing the target file content to the one of the displays through the daisy-chain topology.
